(19) United States
(12) Patent Application Publication
(10) Pub. No.: US 2007/0075009 A1
(43) Pub. Date: Apr. 5, 2007

(54) Aeration system

(76) Inventor: Mario Paris, Knowlton (CA)

Correspondence Address: Eric Fincham, 316 Knowlton Road, Lac Brome, QC, J0E 1V0, CA

(21) Appl. No.: 11/243,553

(22) Filed: Oct. 5, 2005

(51) Int. Cl. B01F 3/04

(52) U.S. Cl. 210/221.1; 210/220

(57) ABSTRACT

A device for aerating a body of liquid comprising an upper portion and a lower portion, the upper portion being a conduit formed of a flexible plastic material with a plurality of apertures formed therein, the apertures being sized to substantially prevent passage of liquid therethrough while permitting passage of low pressure gas, the lower portion comprising a ballast which is welded to the upper conduit. The device may be utilized for aerating water gardens, ponds, sewage basins, and the like.

### FIELD OF THE INVENTION

The present invention relates to a device for treating liquids and more particularly, relates to an aerator for the aeration and mixing of liquids.

### BACKGROUND OF THE INVENTION

Many different situations call for the aeration of liquids. These range from fairly small applications such as water gardens, ponds, etc., to substantially larger applications such as the treatment of waste water and other waste material.

The desirability of aerating relatively small bodies of water such as ponds and the like is well known in the art. The aeration of ponds prevents the stagnation of water and the associated water quality problems; algae formation, muck accumulation, etc.

Other applications include maintaining a concentration of oxygen in the water to allow proper bacterial treatment and aquaculture purposes.

In waste water treatment plants, it is also well established that the use of aerators to introduce oxygen into the waste water to supply the biological oxygen demand (BOD). A similar situation arises on many farms wherein manure is treated with aeration where BOD has to be met.

Many different types of aeration systems are known in the art. All aeration systems use some type of a diffuser which will release gas into the liquid in the form of bubbles. Naturally, it is desirable to produce as fine a bubble pattern as possible as this will increase the rate of absorption into the liquid compared to larger bubbles.

In the water garden and pond market, people are looking for silent and quiet compressors. Generally these compressors operate at a low pressure (2 to 4 psi). Most aeration compressors run at a range of 5 to 10 psi but they are much noisier than the lower pressure ones. This new device allows any type of compressor to be used as it functions at a pressure starting as low as 2 psi.

Generally, diffusion aeration systems use disk aeration which are mounted on portable bases needing ballast to stay at the bottom. Other tubing aeration diffuser systems use lead keel to hold their device at the bottom of the liquid.

### SUMMARY OF THE INVENTION

It is an object of the present invention to provide a device suitable for the aeration of a body of water, and which device overcomes some of the disadvantages of the prior art.

According to one aspect of the present invention, there is provided a device for aerating a body of liquid, the device comprising an upper portion and a lower portion, the upper portion comprising a conduit formed of a flexible plastic material, a plurality of apertures in said conduit, said apertures being sized to substantially prevent passage of the liquid therethrough while permitting passage of low pressure gas therethrough and said lower portion comprising a ballast, said ballast being bead welded to said upper conduit.

As stated above, the upper portion comprises a conduit which is formed of a flexible plastic material. The conduit wall is preferably of a generally circular or oval configuration. The conduit will preferably have a wall thickness of between 0.7 millimetres to 1.5 millimetres.

The conduit wall will have a plurality of apertures formed therein. Preferably, the apertures are arranged in one or more rows although other arrangements could equally well be employed. The apertures are sized to prevent fluid from the outside of the conduit passing interiorly thereof while permitting egress of relatively low pressure air from the conduit to the outside to form tiny bubbles.

The ballast is preferably formed as a solid member and is preferably formed of a material similar to that forming the upper conduit. It may be formed in any configuration desired.

The upper conduits in the lower ballast are secured together and in the preferred embodiment, they are secured together by bead welding as is known in the art. A convenient arrangement is one wherein the upper conduit has a protrusion in the form of a tennon extending therefrom while the ballast has a mortise extending along its longitudinal length. As mentioned above, the two portions may be secured together by welding; however, other means such as adhesive may equally well be utilized.

### BRIEF DESCRIPTION OF THE DRAWINGS

Having thus generally described the invention, reference will be made to the accompanying drawings illustrating an embodiment thereof, in which:

FIG. 1 is a perspective view of the device of the present invention utilized in a water garden/lagoon environment;

FIG. 2 is a cross sectional view of the device;

FIG. 3 is a side elevational view of a portion of the device;

FIG. 4 is an exploded view of the upper conduit and lower ballast; and

FIGS. 5 and 6 illustrate further uses of the device of the present invention.

### DETAILED DESCRIPTION OF THE INVENTION

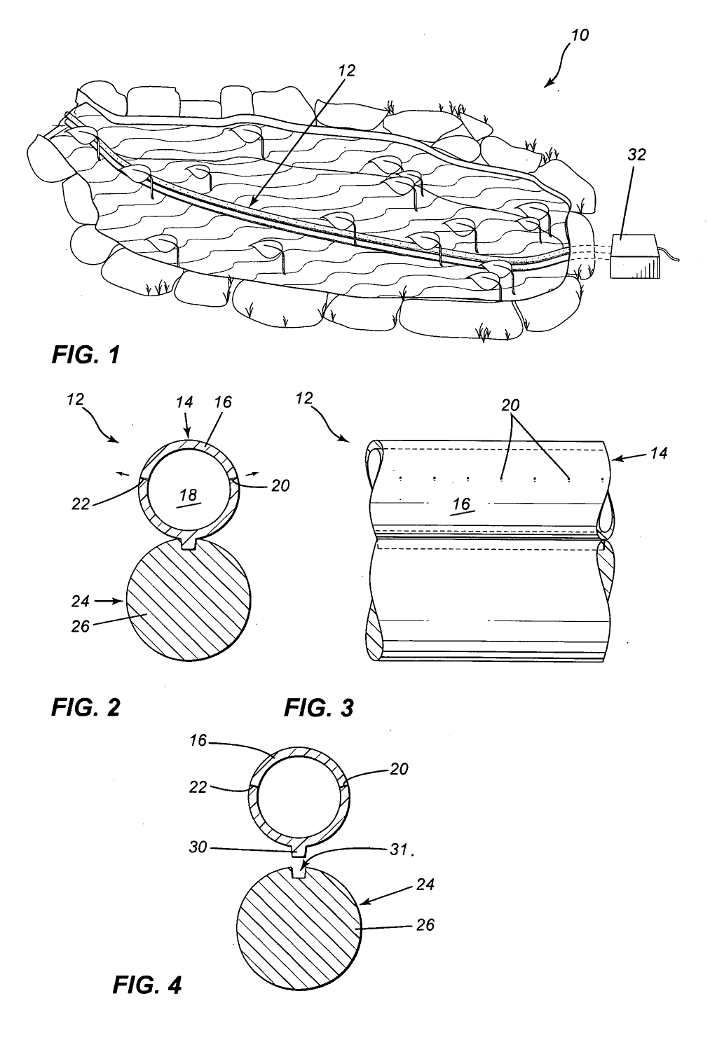

Referring to the drawings in greater detail and by reference characters thereto, there is illustrated in the FIG. 1 a water garden which is generally designated by reference numeral 10. Lying along the bottom of water garden 10 is an aerating device generally designated by reference numeral 12.

Aerating device 12 includes an upper conduit generally designated by reference numeral 14 and which has a generally circular body 16. Interiorly of body 16 is an inner passageway 18.

Formed through body 16 is a line of first apertures 20 while on the opposite side thereof, there is provided a second line of apertures 22. As previously discussed, both apertures 20 and 22 are sized to substantially exclude the passage of water from the outside of body 16 to inner passageway 18 while, at the same time, permitting a passage of low pressure air from inner passageway 18.

Aerating device 12 also includes a lower ballast generally designated by reference numeral 24 and which comprises a solid body 26. As may be seen in FIG. 4, upper conduit 14 is provided with a protrusion in the form of a tenon 30 while solid body 26 has a recess in the form of a mortise 31 extending therealong.

As may be seen in FIG. 1, a low pressure compressor 32 is arranged to provide air to the inner passageway 18.

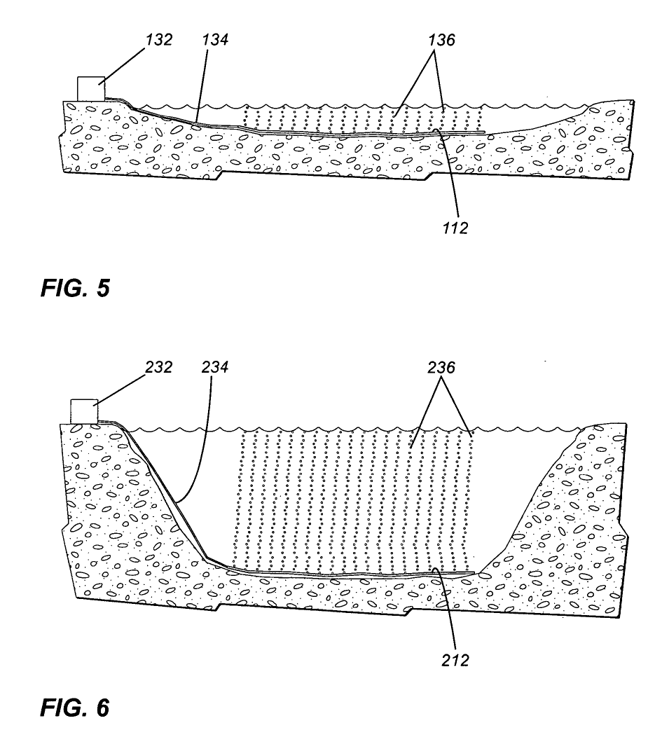

As shown in FIG. 5, a compressor 132 is connected to a lead-in hose 134 and from there to the aerating device 112. The arrangement is shown in a shallow pond. As may be seen, a series of bubbles 136 pass from device 112 upwardly to the surface of the pond.

In FIG. 6, a similar arrangement is illustrated with a compressor 232 providing air to a lead-in hose 234 and aerating device 212 which emits bubbles 236. In this case, compressor 234 may be of the piston or rotating vane type.

The illustrated embodiment provides a very basic example of an aerator as used in a water garden. It will be understood that the device 10 can be installed in any body of liquid, either man-made or naturally occurring wherein it is desired to aerate the same. Such bodies can include lakes, streams, aquaculture ponds, basins, treatment tanks and the like. Similarly, only one aerating device is shown; it will be understood that the aerating device may be arranged in various patterns including a plurality of rows.

The device of the present invention is easy to employ and can readily be removed from the body of liquid wherein it is placed. The material is resistant to most chemicals and thus is suitable for use in many different environments.

It will be understood that the above-described embodiment is for purposes of illustration and that changes and modifications may be made thereto without departing from the spirit and scope of the invention.

I claim:

1. A device for aerating a body of liquid, said device comprising:
an upper portion and a lower portion;
said upper portion comprising a conduit formed of a flexible plastic material, a plurality of apertures in said conduit, said apertures being sized to substantially prevent passage of the liquid therethrough while permitting passage of low pressure gas therethrough; and
said lower portion comprising a ballast, said ballast being welded to said upper conduit.

2. The device of claim 1 wherein both said upper conduit and said ballast are formed of a like material.

3. The device of claim 2 wherein said material is a PVC.

4. The device of claim 3 wherein said apertures are substantially circular in configuration and have diameter of between one and three millimetres.

5. The device of claim 1 wherein said upper conduit has at least one protrusion extending exteriorally thereof, and said ballast has a recess sized to receive said protrusion.

6. The device of claim 5 wherein said protrusion comprises a continuous tennon and said recess comprises a mortise.
